(19) United States
(12) Patent Application Publication
(10) Pub. No.: US 2024/0144362 A1
(43) Pub. Date: May 2, 2024

(54) SERVER DEVICE FOR CREATING AND MANAGING MULTIPLE RECORD NUMBERS THROUGH SINGLE BANKING SYSTEM ACCOUNT

(71) Applicant: Nexben, Inc., Minneapolis, MN (US)

(72) Inventors: John Kelly, Minneapolis, MN (US); Mark Pontliana, Minneapolis, MN (US)

(21) Appl. No.: 18/574,632

(22) PCT Filed: Jul. 23, 2021
(86) PCT No.: PCT/US2021/042876

§ 371 Date: Dec. 27, 2023

(51) Int. Cl. G06Q 40/02

(52) U.S. Cl. CPC G06Q 40/02

(57) ABSTRACT

A server device receives an enrollment indication from an employer computing device, wherein the enrollment indication includes personal information for each of a plurality of employees for an employer. For each employee of the plurality of employees, the server device assigns a unique record number to the respective employee, wherein each unique record number assigned by the server device includes a same alphanumeric string at a same position as a portion of the unique record number. The server device stores an indication of the same alphanumeric string and the same position at a banking system at which an entity associated with the server device holds an individual account.

### BACKGROUND

A health reimbursement arrangement (HRA) is a plan set up by an employer to cover medical expenses for its employees. The employer ultimately decides how much it will put into the plan, and the employee can request reimbursement for actual medical expenses incurred up to that amount. Employers are allowed to claim a tax deduction for the reimbursements they make through these plans, and reimbursement dollars received by employees are generally tax-free.

One particular type of HRA is an individual coverage HRA (ICHRA). As of January 2020, the United States government allows employers to offer their employees an ICHRA in lieu of group health insurance. Employees can use these ICHRAs to buy their own comprehensive individual health insurance with pretax dollars either through the employer or on the Affordable Care Act's (ACA) health insurance marketplace.

When setting up these ICHRAs, employees are generally given individual accounts through a banking service. When transactions are charged against this account for an employee's ICHRA, the banking service must receive the full identification information for the account, be able to process these types of transactions, understand the tax implications, and verify the healthcare premium expense associated with the reimbursement. Furthermore, as these bank accounts are funded by the employer, the money is generally a post-tax reimbursement to employees who used their own dollars to fund such an account, limiting the tax benefits for the employee. This system also limits the tax benefits for employers. This is in addition to forcing numerous processes and data structures onto the bank's systems.

### SUMMARY

In general, the techniques of this disclosure provide a solution by aggregating multiple of these accounts into a single account on the banking side. A server device, distinct from any device on the banking system, will process the creation of the various records and keep track of these individual records on the server side. However, as this is simply a record stored on a local server, the individual record is not an actual bank account with a federally-insured institution. Rather, the record will track each individual's piece of the overall account fund that is stored with the federally-insured institution.

The server device will contact the banking system to create a single account, either for every employer that accesses the server or for an individual employer utilizing the server. The server device will also create a rule with the banking system that every individual employee record on the server device, which will pass through the banking system, will have a common alphanumeric string within the record identifier. When the banking system receives a transaction where the record identifier in the transaction includes the common alphanumeric string, the banking system will cease processing the transaction until the banking system receives verification and validation from the server device (although, in some instances, a hold may be placed on the account). Instead, the transaction information will be forwarded to the server device so that the server device may perform the processing of the transaction based on the specific ICHRA rules set by the employer and federal statutes. Upon locally verifying and validating the transaction, the server device instructs the banking system to either complete or deny the transaction.

This provides numerous benefits. Technologically, by limiting evaluation at the banking system, the processors of the banking system have additional bandwidth to process other transactions at the banking system, which can number up to 38,000 transactions per second, in some instances. Instead of performing the additional processing needed to verify the legality of the payments as opposed to simply whether there is available funding, the banking system offloads this process onto a separate server device designed and optimized specifically for these functions. Additionally, since the server device keeps accurate ledgers of the funds available to each employees, there is no risk of overdrawing the accounts, which create additional processing, legal, and credit issues at the banking system. Instead, when the server device processes the transaction and can decline the payment without involving the banking system at all if the funds are not available, or can adjust the payment to match the available funds if the payment request is for an amount greater than the available funds. This handling further optimizes the system and reduces the overall processing in the system, improving the functioning of the technology in and of itself.

Additionally, by going through an individual record on the server device, the employer is able to take these deductions out of pre-tax dollars. This greatly increases the cash flow of for the employer when dealing with employee-related health insurance expenses.

In one example, the disclosure is directed to a method that includes an enrollment indication from an employer computing device, wherein the enrollment indication includes personal information for each of a plurality of employees for an employer. The method further includes, for each employee of the plurality of employees, assigning, by the server device, a unique record number to the respective employee, wherein each unique record number assigned by the server device includes a same alphanumeric string at a same position as a portion of the unique record number. The method also includes storing, by the server device, an indication of the same alphanumeric string and the same position at a banking system at which an entity associated with the server device holds an individual account.

In another example, the disclosure is directed to a server device configured to receive an enrollment indication from an employer computing device, wherein the enrollment indication includes personal information for each of a plurality of employees for an employer. The server device is further configured to, for each employee of the plurality of employees, assign a unique record number to the respective employee, wherein each unique record number assigned by the server device includes a same alphanumeric string at a same position as a portion of the unique record number. The server device is also configured to store an indication of the same alphanumeric string and the same position at a banking system at which an entity associated with the server device holds an individual account.

In another example, the disclosure is directed to a non-transitory computer-readable storage medium containing instructions. The instructions, when executed, cause one or more processors to receive an enrollment indication from an employer computing device, wherein the enrollment indication includes personal information for each of a plurality of employees for an employer. The instructions, when executed, further cause the one or more processors to, for each employee of the plurality of employees, assign a unique record number to the respective employee, wherein each unique record number assigned by the server device includes a same alphanumeric string at a same position as a portion of the unique record number. The instructions, when executed, also cause the one or more processors to store an indication of the same alphanumeric string and the same position at a banking system at which an entity associated with the server device holds an individual account.

In another example, the disclosure is directed to a system that includes an employer computing device, a banking server, and a portal server. The portal server is configured to receive an enrollment indication from the employer computing device, wherein the enrollment indication includes personal information for each of a plurality of employees for an employer. The portal server is further configured to, for each employee of the plurality of employees, assign a unique record number to the respective employee, wherein each unique record number assigned by the server device includes a same alphanumeric string at a same position as a portion of the unique record number. The portal server is also configured to store an indication of the same alphanumeric string and the same position at the banking server operated by an entity associated with the server device where an operator of the server device holds an individual account. The banking server is configured to receive an indication of a first transaction containing transaction information and a transaction account number. The banking server is further configured to parse the transaction account number to determine whether the transaction account number contains the same alphanumeric string at the same position as a portion of the transaction account number. The banking server is also configured to, in response to determining that the transaction account number includes the same alphanumeric string at the same position, send the indication of the first transaction to the portal server. The portal server is further configured to receive the indication of the first transaction from the banking server and process the first transaction.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an environment in which a server creates local record numbers to each correspond to a single account at a banking system, in accordance with one or more of the techniques described herein.

FIG. 2 is a block diagram illustrating a more detailed example of a computing device configured to perform the techniques described herein.

FIG. 3 is a flowchart illustrating an example technique described herein.

FIG. 4 is a flowchart illustrating an example technique described herein.

### DETAILED DESCRIPTION

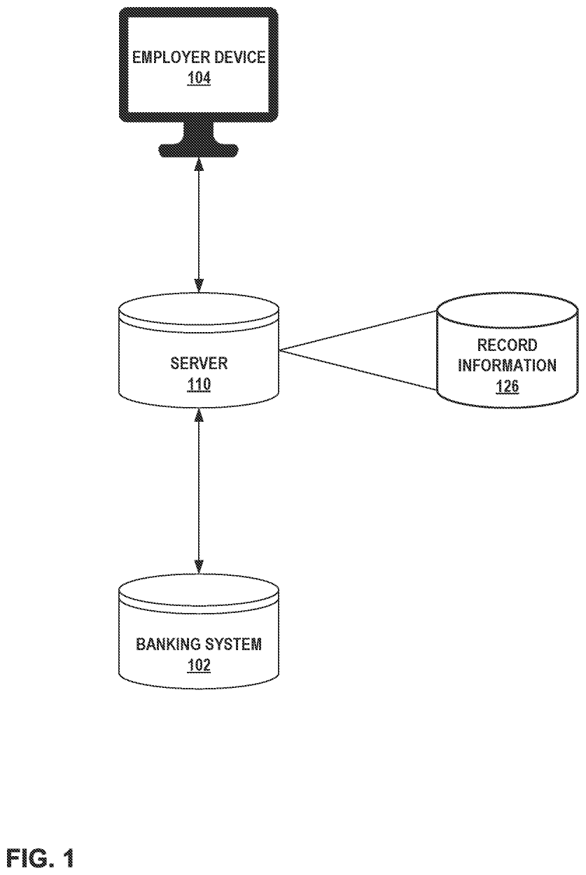

FIG. 1 is a block diagram illustrating an environment in which a server generates contribution amounts from different sources and presents those amounts in a same user interface, in accordance with one or more of the techniques described herein. FIG. 1 includes employer computing device 104, which can be any computing device where a user can access a web application, portal application, or web page provided by server 110, including a mobile computing device (e.g., a smartphone, a tablet computer, a laptop computer, etc.), a desktop computer, a smarthome component (e.g., a computerized appliance, a home security system, a wearable computing device (e.g., a smart watch, computerized glasses, smart headphones, etc.), a virtual reality/augmented reality/extended reality (VR/AR/XR) system, or a video game or streaming system, among other things.

FIG. 1 also includes server 110. Server 110 may be configured to communicate with employer computing device 104 over a wired or wireless connection, such as an Internet connection, a cellular connection, a radio connection, or any other connection suitable for transmitting data. Server 110 may be any computer with the processing power required to adequately execute the techniques described herein. For instance, server device 210 may be any one or more of a server system, a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, smart headphones, etc.), a virtual reality/augmented reality/extended reality (VR/AR/XR) system, a video game or streaming system, a network modem, router, or any other computerized device that may be configured to perform the techniques described herein. Server 110 may store record information 126 either locally or remotely on another device accessible by server 110.

Banking system 102 may be an additional server or computing device that may host a number of accounts for an electronic or a brick-and-mortar bank. Banking system 102 may perform all of the functions of a typical bank, including opening and maintaining savings accounts, checking accounts, investment accounts, cryptocurrency accounts, retirement accounts, or any other type of account where a user may deposit or withdraw funds of some sort.

In a typical use case, when an employee has an ICHRA through their employer, they will open a banking account at banking system 102. The account will be funded using funds provided by the employer. When the user wishes to use the funds in the ICHRA to pay for, reimburse, or otherwise utilize funds from the ICHRA to pay for covered expenses (e.g., health insurance premiums), the user submits the transaction to banking system 102 directly. Banking system 102 then treats the transaction like any other transaction, dispersing the requested funds. In doing so, banking system 102 may perform limited checks on the reasons for the fund dispersal, and the user is at risk for overdrafting the account if they are not aware of the true amount of funds in the account.

In accordance with the techniques described herein, server 110 receives an enrollment indication from employer computing device 104. This enrollment indication includes personal information for each of a plurality of employees for an employer that operates employer computing device 104. For each employee of the plurality of employees, server 110 assigns a unique record number to the respective employee, storing those associations in record information 126. However, as this is simply a record stored on server 110, the individual record is not an actual bank account with a federally-insured institution (e.g., banking system 102). Rather, the record will track each individual's piece of the overall account fund that is stored with the federally-insured institution.

In assigning the unique record number to the respective employee, server 110 follows a rule where each unique record number assigned by server 110 includes a same alphanumeric string at a same position as a portion of the unique record number (e.g., the first four characters are “4294,” the final four characters are “890A,” characters 3-6 are “5612,” etc.). Server device 110 may store this rule at banking system 102, either by collaborating with banking system 102 such that banking system 102 is aware of the rule during the establishment of the rule or by sending the rule to banking system 102 upon creation. As such, when banking system 102 receives a transaction associated with an account number that includes that same alphanumeric string at the same position as defined by the rule, banking system 102 may send the transaction to server 110 from processing, in some instances refraining from completely processing the transaction at banking system 102. Server 110 may then analyze the transaction to ensure that adequate funds are available and that the funds are being used for a legal and adequate purpose before issuing funds from a group account held by an operator of server 110 at banking system 102. If server 110 does verify that the transaction is proper, server 110 may send instructions to banking system 102 to complete the processing of the transaction.

By performing these techniques, server 110 improves the efficiency and operability of the overall system. This provides numerous benefits. Technologically, by limiting evaluation at banking system 102, the processors of banking system 102 have additional bandwidth to process other transactions at banking system 102, which can number up to 38,000 transactions per second, in some instances. Instead of performing the additional processing needed to verify the legality of the payments as opposed to simply whether there is available funding, banking system 102 offloads this process onto a separate server 110 designed and optimized specifically for these functions. Additionally, since server 110 keeps accurate ledgers of the funds available to each employees in record information 126, there is no risk of overdrawing the accounts, which create additional processing, legal, and credit issues at banking system 102. Instead, when server device 110 processes the transaction and can decline the payment without involving banking system 102 at all if the funds are not available for the particular user requesting payment, or server device 110 can adjust the payment to match the available funds if the payment request is for an amount greater than the available funds. This handling further optimizes the system and reduces the overall processing in the system, improving the functioning of the technology in and of itself.

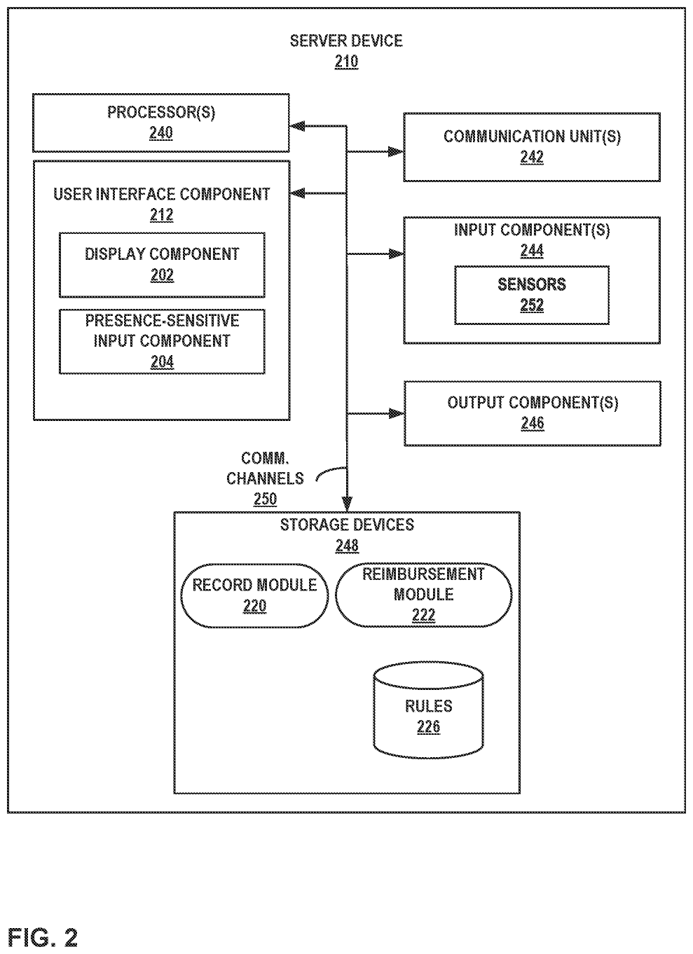

FIG. 2 is a block diagram illustrating a more detailed example of a computing device configured to perform the techniques described herein. Server device 210 of FIG. 2 is described below as an example of computing device 110 of FIG. 1. FIG. 2 illustrates only one particular example of server device 210, and many other examples of server device 210 may be used in other instances and may include a subset of the components included in example server device 210 or may include additional components not shown in FIG. 2.

Server device 210 may be any computer with the processing power required to adequately execute the techniques described herein. For instance, server device 210 may be any one or more of a server system, a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, smart headphones, etc.), a virtual reality/augmented reality/extended reality (VR/AR/XR) system, a video game or streaming system, a network modem, router, or any other computerized device that may be configured to perform the techniques described herein.

As shown in the example of FIG. 2, server device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of server device 210 include record module 220, reimbursement module 222, and rules data store 226.

One or more processors 240 may implement functionality and/or execute instructions associated with server device 210 to dynamically create multiple individual records that are each connected with a singular banking account. That is, processors 240 may implement functionality and/or execute instructions associated with server device 210 to take employee information stored in rules data store 226, and assign record numbers to those employees with a common rule known to a banking system such that the banking system may still receive those transactions but associate those transactions with server device 210, as those records may not explicitly exist at the banking system.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of server device 210. For example, processors 240 of server device 210 may retrieve and execute instructions stored by storage components 248 that cause processors 240 to perform the operations described with respect to modules 220 and 222. The instructions, when executed by processors 240, may cause server device 210 to create special record numbers for employees in a system, with each record number following a specific rule that causes a particular substring of the record number, less than the entirety of the record number, to have the same characters at the same position within the overall string of the record number.

Record module 220 may execute locally (e.g., at processors 240) to provide functions associated with generating unique record numbers for employees. In some examples, record module 220 may act as an interface to a remote service accessible to server device 210. For example, record module 220 may be an interface or application programming interface (API) to a remote server that generates the unique record numbers that follow a specific rule that causes a particular substring of the record number, less than the entirety of the record number, to have the same characters at the same position within the overall string of the record number.

In some examples, subsidy module 222 may execute locally (e.g., at processors 240) to maintain and update a ledger of funds available for each unique record number generated by record module 220 and to interface with a banking system to maintain and update funds stored the singular bank record associated with server device 210. In some examples, subsidy module 222 may act as an interface to a remote service accessible to server device 210. For example, subsidy module 222 may be an interface or application programming interface (API) to a remote server that maintains and updates a ledger of funds available for each unique record number generated by record module 220 and interfaces with a banking system to maintain and updates funds stored the singular bank record associated with server device 210.

One or more storage components 248 within server device 210 may store information for processing during operation of server device 210 (e.g., server device 210 may store data accessed by modules 220 and 222 during execution at server device 210). In some examples, storage component 248 is a temporary memory, meaning that a primary purpose of storage component 248 is not long-term storage. Storage components 248 on server device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, and data store 226. Storage components 248 may include a memory configured to store data or other information associated with modules 220 and 222, and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of server device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of server device 210 may receive input. Examples of input are tactile, audio, and video input. Input components 244 of server device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of server device 210 may generate output in a selected modality. Examples of modalities may include a tactile notification, audible notification, visual notification, machine generated voice notification, or other modalities. Output components 246 of server device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of server device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of server device 210, UIC 212 may also represent an external component that shares a data path with server device 210 for transmitting and/or receiving input and output. For instance, in one example, UIC 212 represents a built-in component of server device 210 located within and physically connected to the external packaging of server device 210 (e.g., a screen on a mobile phone). In another example, UIC 212 represents an external component of server device 210 located outside and physically separated from the packaging or housing of server device 210 (e.g., a monitor, a projector, etc. that shares a wired and/or wireless data path with server device 210).

UIC 212 of server device 210 may detect two-dimensional and/or three-dimensional gestures as input from a user of server device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, record module 220 receives an enrollment indication from an employer computing device. The enrollment indication includes personal information for each of a plurality of employees for an employer, which record module 220 stores in rules 226.

In some instances, record module 220 further sends the enrollment indication to a carrier via a broker. The carrier may create an individual policy and profile for each of the employees of the plurality of employees. The profile may include information such as personally identifying information for the employee, a billing identification for the employee, or carrier-specific details for the individual policy of the employee. Record module 220 may then receive the individual policy and the profile for each employee of the plurality of employees. Record module 220 may update an employee database in rules 226 to include the individual policy and the profile for each employee of the plurality of employees. In this way, record module 220 may track and maintain all of the information needed to process ICHRA payments and all other health-related tasks for an individual locally rather than relying on separate outside devices to consistently transmit data and handle these tasks.

For each employee of the plurality of employees in rules 226, record module 220 assigns a unique record number to the respective employee in rules 226. Each unique record number assigned by record module 220, while unique in its entirety, includes a same alphanumeric string at a same position as a portion of the unique record number as a rule. In other words, while each string of characters in a unique record number may be a unique set of 12 characters, 16 characters, or some other number of characters, within each record number is a sub string of a certain number of characters in a certain position that are identical across each record number. The same alphanumeric string may be a string of characters that includes any one or more of number characters (e.g., 0-9, etc.), alphabetic characters (e.g., A-Z, both uppercase and lowercase, etc.), or symbols (e.g., ‘!’, ‘@’, ‘#’, etc.).

In some instances, in assigning the unique record number, record module 220 may, for each employee of the plurality of employees, assign the unique record number to the respective employee utilizing a model. That model may instruct record module 220 to follow the rule set up by server device 210 and/or the banking system such that each unique record number meets the necessary criteria. In some instances, the model may be expanded to have unique rules for each individual employer or entity that utilizes the techniques of server device 210 to operate and maintain their particular ICHRA funds.

Record module 220 stores an indication of the same alphanumeric string and the same position at a banking system at which an entity associated with the server device holds an individual account. Record module 220 may either send the rule to the banking system or may collaborate with the banking system to create the rule such that the banking system may store an indication of the rule based on the collaboration.

In some instances, when banking system receives a transaction that includes a transaction account number that meets the rule instituted by server device 210 and record module 220 in creating record numbers, the banking system may send that transaction to reimbursement module 222. The banking system, in some instances, may also refrain from completing the processing on the transaction after determining that the record number has the same alphanumeric string at the same position as defined by the instituted rule. Rather, reimbursement module 222 may verify that the transaction is proper and, upon doing so, send instructions to the banking system to complete the processing of the transaction after the processing is validated on server device 210.

Reimbursement module 222 may receive an indication of a first transaction containing transaction information and a transaction account number from the banking system. The transaction account number includes the same alphanumeric string and the same position, and wherein the transaction account number matches a first unique record number for a first employee of the plurality of employees. Reimbursement module 222 may then process the first transaction, either in addition to or in lieu of processing performed by the banking system.

In some examples, in processing the first transaction, reimbursement module 222 may retrieve ledger information from rules 226 for the transaction account number from an employee database. The ledger information may include an account balance such that reimbursement module 222 may verify that a payment amount included in the transaction information is less than or equal to the account balance. In response to verifying that the payment amount is less than or equal to the account balance, reimbursement module 222 may issue a first payment to the first employee for the payment amount and using funds from the individual account. Conversely, in response to verifying that the payment amount is greater than the account balance, reimbursement module 222 may issue a second payment to the first employee for the account balance of the transaction account number using funds from the individual account.

When issuing the first payment, reimbursement module 222 may send an indication of a second transaction to the banking system. The second transaction may include the payment amount, at least a portion of the personal information for the first employee, and an account number for the individual account held by the entity associated with server device 210. As the funds are mixed into a single account, record module 220 may update the ledger information for the transaction account number by subtracting the payment amount from the account balance to obtain a new account balance for the transaction account number in order to keep an accurate record of the amount of funds available to the individual employee out of the total amount of funds available in the individual account. The banking system may then process the second transaction.

In other instances, in processing the first transaction, reimbursement module 222 may analyze the transaction information to determine a purpose of the first transaction. This purpose may be any one or more of a product purchased, a service administered, or a goods consumption. Reimbursement module 222 may then determine whether the purpose of the first transaction constitutes a valid healthcare premium transaction under statutory law. In response to determining that the purpose of the first transaction constitutes the valid healthcare premium transaction, reimbursement module 222 may initiate a payment process using funds from the individual account. Conversely, in response to determining that the purpose of the first transaction does not constitutes the valid healthcare premium transaction, reimbursement module 222 may either initiate a decline action for the first transaction or simply refrain from processing the transaction any further. As ICHRA funds may only be applied to premium payments for health insurance products, reimbursement module 222 may process transactions in this way to verify that the user is not using ICHRA for invalid purposes.

Server device 210 may handle multiple employers. For instance, record module 220 may receive a second enrollment indication from a second employer computing device. The second enrollment indication includes personal information for each of a second plurality of employees for a second employer. For each employee of the second plurality of employees, record module 220 may assign a unique record number to the respective employee from the second plurality of employees. Each unique record number assigned by record module 220 may include a second same alphanumeric string at a second same position as a portion of the unique record number, where the second same alphanumeric string is different than the same alphanumeric string. In other words, record module 220 may differentiate between different employers by using different rules and different common alphanumeric strings when creating the record numbers for each employee. Similarly, server device 210 may utilize same or different banking systems to execute this payment model for the second employer as for the first employer, and if a same banking system is used, a same or a different individual account may hold funds for the second employer as compared to the first employer.

In other instances, for the second employer, record module 220 may receive a second enrollment indication from a second employer computing device, with the second enrollment indication including personal information for each of a second plurality of employees for a second employer. In this instance, record module 220 may, for each employee of the second plurality of employees, assign a unique record number to the respective employee, where each unique record number assigned by record module 220 includes the same alphanumeric string at the same position as a portion of the unique record number. In other words, the same rule (e.g., the same alphanumeric string at the same position) may be used across different employers. In those instances, record module 220 and reimbursement module 222 may utilize the ledger information in rules 226 to differentiate between different employers in addition to different employees within the same employer.

In some instances, server device 210 may receive an indication of a payment from the employer to fund the individual account for the entity associated with server device 210. Server device 210 may then deposit that payment into the individual account held by the entity associated with server device 210. Utilizing the techniques described herein, that payment may legally be a pre-tax payment from the employer.

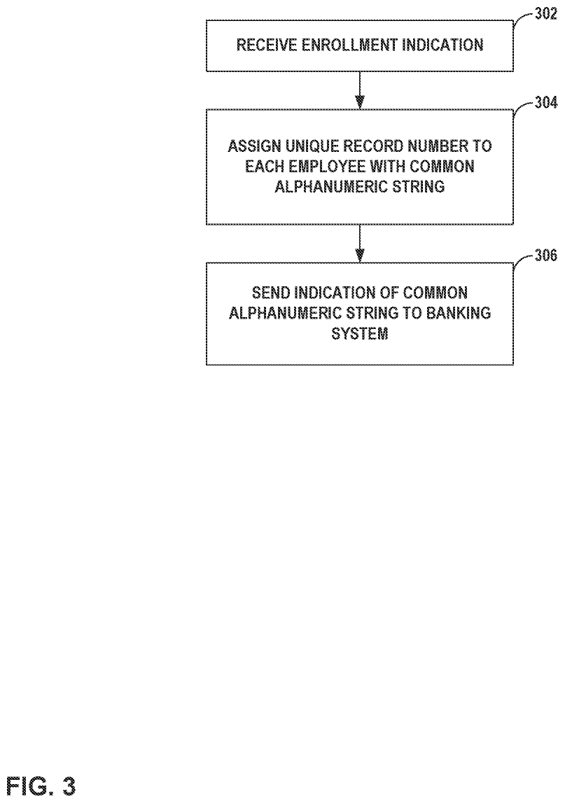

FIG. 3 is a flowchart illustrating an example technique described herein for generating unique record numbers for each employee of an employer to handle ICHRA payments. The techniques of FIG. 3 may be performed by one or more processors of a computing device, such as server 110 of FIG. 1 and/or server device 210 illustrated in FIG. 2. For purposes of illustration only, the techniques of FIG. 3 are described within the context of server device 210 of FIG. 2, although computing devices having configurations different than that of server device 210 may perform the techniques of FIG. 3.

In accordance with the techniques described herein, record module 220 receives an enrollment indication from an employer computing device (302). The enrollment indication includes personal information for each of a plurality of employees for an employer. For each employee of the plurality of employees, record module 220 assigns a unique record number to the respective employee (304). Each unique record number assigned by the server device includes a same alphanumeric string at a same position as a portion of the unique record number. Record module 220 stores an indication of the same alphanumeric string and the same position at a banking system at which an entity associated with the server device holds an individual account (306), either by sending the banking system the rule or collaborating with the banking system to develop the rule.

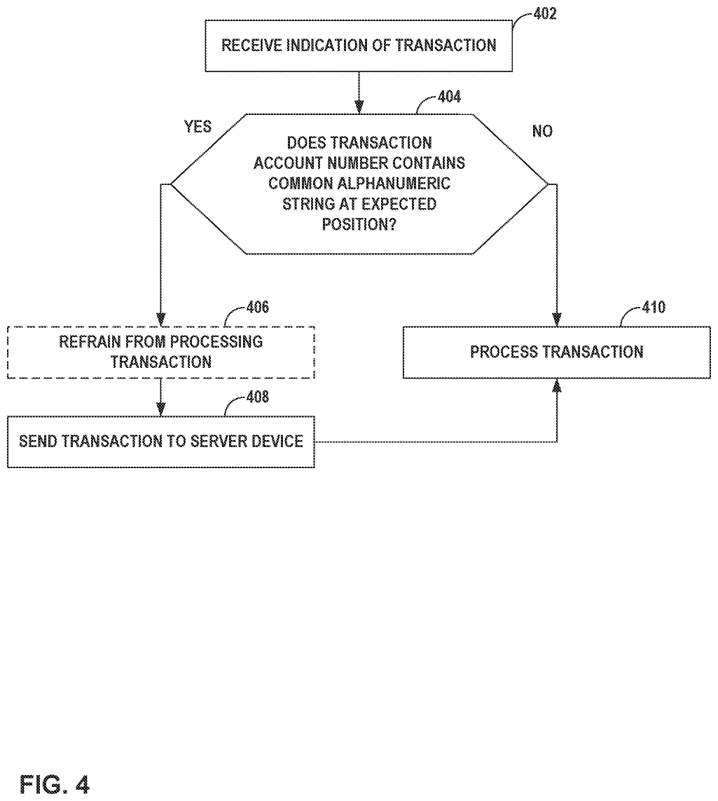

FIG. 4 is a flowchart illustrating an example technique described herein for a banking system to handle a transaction for an ICHRA payment. The techniques of FIG. 4 may be performed by one or more processors of a computing device, such as server 110 of FIG. 1 and/or server device 210 illustrated in FIG. 2. For purposes of illustration only, the techniques of FIG. 4 are described within the context of banking system 102 of FIG. 1, although computing devices having configurations different than that of banking system 102 may perform the techniques of FIG. 4.

In accordance with the techniques described herein, banking system 102 receives an indication of a first transaction containing transaction information and a transaction account number (402). Banking system 102 parses the transaction account number to determine whether the transaction account number contains the same alphanumeric string at the same position as a portion of the transaction account number (404). In response to determining that the transaction account number includes the same alphanumeric string at the same position (“YES” branch of 404), banking system 102 sends the indication of the first transaction to server 110 (408). In some instances, banking system 102 may also temporarily refrain from processing the first transaction any further (406). Rather, server 110 may analyze the transaction based on locally stored records and verify that the transaction is valid. Upon verifying and validating the transaction, server 110 may send instructions to banking system 102 to complete the transaction, where banking system 102 will continue processing the first transaction (102).

Conversely, in response to determining that the transaction account number does not include the same alphanumeric string at the same position (“NO” branch of 404), banking system 102 processes the first transaction at it would any transaction that comes into banking system 102 (410).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving, by a server device, an enrollment indication from an employer computing device, wherein the enrollment indication includes personal information for each of a plurality of employees for an employer;
for each employee of the plurality of employees, assigning, by the server device, a unique record number to the respective employee, wherein each unique record number assigned by the server device includes a same alphanumeric string at a same position as a portion of the unique record number; and
storing, by the server device, an indication of the same alphanumeric string and the same position at a banking system at which an entity associated with the server device holds an individual account.

2. The method of claim 1, wherein the same alphanumeric string comprises a string that includes one or more of:
number characters;
alphabetic characters; or
symbols.

3. The method of claim 1, wherein assigning the unique record number comprises, for each employee of the plurality of employees, assigning, by the server device and utilizing a model, the unique record number to the respective employee.

4. The method of claim 1, further comprising:
receiving, by the server device, an indication of a first transaction containing transaction information and a transaction account number from the banking system, wherein the transaction account number includes the same alphanumeric string and the same position, and wherein the transaction account number matches a first unique record number for a first employee of the plurality of employees; and
processing, by the server device, the first transaction.

5. The method of claim 4, wherein processing the first transaction comprises:
retrieving, by the server device, ledger information for the transaction account number from an employee database, wherein the ledger information includes an account balance;
verifying, by the server device, that a payment amount included in the transaction information is less than or equal to the account balance;
in response to verifying that the payment amount is less than or equal to the account balance, issuing, by the server device, a first payment to the first employee for the payment amount and using funds from the individual account; and
in response to verifying that the payment amount is greater than the account balance, issuing, by the server device, a second payment to the first employee for the account balance of the transaction account number using funds from the individual account.

6. The method of claim 5, wherein issuing the first payment comprises:
sending, by the server device, an indication of a second transaction to the banking system, wherein the second transaction includes the payment amount, at least a portion of the personal information for the first employee, and an account number for the individual account; and
updating the ledger information for the transaction account number by subtracting the payment amount from the account balance to obtain a new account balance for the transaction account number,
wherein the banking system processes the second transaction.

7. The method of claim 4, wherein processing the first transaction comprises:
analyzing, by the server device, the transaction information to determine a purpose of the first transaction, wherein the transaction information includes one or more of a product purchased, a service administered, and a goods consumption;
determining, by the server device, whether the purpose of the first transaction constitutes a valid healthcare premium transaction under statutory law;
in response to determining that the purpose of the first transaction constitutes the valid healthcare premium transaction, initiating, by the server device, a payment process using funds from the individual account; and
in response to determining that the purpose of the first transaction does not constitutes the valid healthcare premium transaction, initiating, by the server device, a decline action for the first transaction.

8. The method of claim 1, further comprising:
sending, by the server device, the enrollment indication to a carrier via a broker, wherein the carrier creates an individual policy and profile for each of the employees of the plurality of employees;
receiving, by the server device, the individual policy and the profile for each employee of the plurality of employees; and
updating, by the server device, an employee database to include the individual policy and the profile for each employee of the plurality of employees.

9. The method of claim 8, wherein the profile for each employee of the plurality of employees include one or more of:
personally identifying information for the employee;
a billing identification for the employee; and
carrier-specific details for the individual policy of the employee.

10. The method of claim 1, further comprising:
receiving, by the server device, an indication of a payment from the employer to fund the individual account for the entity associated with the server device; and
depositing, by the server device, the payment into the individual account.

11. The method of claim 10, wherein the payment comprises a pre-tax payment from the employer.

12. The method of claim 1, further comprising:
receiving, by the server device, a second enrollment indication from a second employer computing device, wherein the second enrollment indication includes personal information for each of a second plurality of employees for a second employer;
for each employee of the second plurality of employees, assigning, by the server device, a unique record number to the respective employee, wherein each unique record number assigned by the server device includes a second same alphanumeric string at a second same position as a portion of the unique record number, wherein the second same alphanumeric string is different than the same alphanumeric string; and
sending, by the server device, an indication of the second same alphanumeric string and the second same position to a second banking system at which an entity associated with the server device holds a second individual account.

13. The method of claim 12, wherein the second banking system is a same banking system as the banking system.

14. The method of claim 13, wherein the second individual account is a same individual account as the individual account.

15. The method of claim 13, wherein the second individual account is different than the individual account.

16. The method of claim 12, wherein the second banking system is different than the banking system.

17. The method of claim 1, further comprising:
receiving, by the server device, a second enrollment indication from a second employer computing device, wherein the second enrollment indication includes personal information for each of a second plurality of employees for a second employer;
for each employee of the second plurality of employees, assigning, by the server device, a unique record number to the respective employee, wherein each unique record number assigned by the server device includes the same alphanumeric string at the same position as a portion of the unique record number.

18. A system comprising:
an employer computing device;
a banking server; and
a portal server configured to:
receive an enrollment indication from the employer computing device, wherein the enrollment indication includes personal information for each of a plurality of employees for an employer;
for each employee of the plurality of employees, assign a unique record number to the respective employee, wherein each unique record number assigned by the server device includes a same alphanumeric string at a same position as a portion of the unique record number; and
store an indication of the same alphanumeric string and the same position at the banking server operated by an entity associated with the server device where an operator of the server device holds an individual account,
wherein the banking server is configured to:
receive an indication of a first transaction containing transaction information and a transaction account number;
parse the transaction account number to determine whether the transaction account number contains the same alphanumeric string at the same position as a portion of the transaction account number; and
in response to determining that the transaction account number includes the same alphanumeric string at the same position:
send the indication of the first transaction to the portal server,
wherein the portal server is further configured to:
receive the indication of the first transaction from the banking server; and
process the first transaction.

19. The system of claim 18, wherein the banking server is further configured to:
refrain from processing the first transaction; and
create a rule to send all transactions where transaction information indicates that a transaction account number includes the same alphanumeric string at the same position of the transaction account number to the portal server.

20. A non-transitory computer-readable storage medium containing instructions that, when executed, cause one or more processors of a server device to:
receive an enrollment indication from an employer computing device, wherein the enrollment indication includes personal information for each of a plurality of employees for an employer;
for each employee of the plurality of employees, assign a unique record number to the respective employee, wherein each unique record number assigned by the server device includes a same alphanumeric string at a same position as a portion of the unique record number; and
store an indication of the same alphanumeric string and the same position at a banking system at which an entity associated with the server device holds an individual account.
